(19) United States
(12) Patent Application Publication
(10) Pub. No.: US 2018/0165724 A1
(43) Pub. Date: Jun. 14, 2018

(54) METHOD AND SYSTEM FOR CONTEXTUAL BUSINESS INTELLIGENCE REPORT GENERATION AND DISPLAY

(71) Applicant: INTERNATIONAL BUSINESS MACHINES CORPORATION, Armonk, NY (US)

(72) Inventors: Sarbajit K. Rakshit, Kolkata (IN); Siddharth K. Saraya, Burdwan (IN)

(21) Appl. No.: 15/376,839

(22) Filed: Dec. 13, 2016

(51) Int. Cl. G06Q 30/02; G06F 17/30; G06Q 50/00

(52) U.S. Cl. CPC G06Q 30/0282; G06Q 50/01; G06F 17/30979

(57) ABSTRACT

A method, system and computer program for generating a business intelligence report, comprising the steps of providing a user-operated device, whereby a user selects at least one keyword from an electronic document displayed on the user-operated device. The user then defines a contextual relationship between the keyword(s) and a business intelligence issue by way of annotations input by the user into the user-operated device. A search is performed on information stored in a business intelligence system based on the keyword(s) and the contextual relationship based, and a business intelligence report is generated based on a result of the search. The search is performed on an organization data dictionary and a structured ontology hierarchy stored in the business intelligence system. The contextual relationship comprises written text, a diagram or other annotations made by the user.

### TECHNICAL FIELD

The present invention relates to capturing and managing contextual search requirements for business intelligence reports from outside applications, and also relates to accelerated project and report development by providing user interaction on non-business intelligence report content.

### BACKGROUND

Business intelligence (BI) reports are notoriously difficult to capture and are often limited to static business data environments.

For conventional business intelligence reporting system, business users are required to open business intelligence reporting applications to view relevant reports, graphs, etc. While navigating conventional business intelligence reports, the user can select different dimensions, measures, filters, etc. to view business intelligence data. Business users also browse different non business intelligence reports, newspapers, blogs, social media and other documents, which are generated in text format and may have embedded images. Products names, customer names and other relevant information are also written in the same text content. Thus, while reading such text content users may wish to know business intelligence information in the context of specific keywords in this content. For example, when reviewing a product that has been published in a social networking site a user may like to know the sales details of the product via a business intelligence report based on information provided by the social networking site.

Thus, the need exists for a method and system whereby a user may generate a business intelligence report while reviewing on-line or off-line business information outside the context of a business intelligence report. Currently, a business user must open a business intelligence tool and then select filters and objects respectively to generate a relevant business intelligence report, which is inconvenient and inefficient.

### SUMMARY OF THE INVENTION

The present invention is directed to solving issues relating to one or more of the problems presented in the prior art, as well as providing additional features that will become readily apparent by reference to the following detailed description when taken in conjunction with the accompanying drawings.

A method, system and computer program for generating a business intelligence report, comprising the steps of providing a user-operated device, whereby a user selects at least one keyword from an electronic document displayed on the user-operated device. The user then defines a contextual relationship between the keyword(s) and a business intelligence issue by way of annotations input by the user into the user-operated device. A search is performed on information stored in a business intelligence system based on the keyword(s) and the contextual relationship based, and a business intelligence report is generated based on a result of the search. The search is performed on an organization data dictionary and a structured ontology hierarchy stored in the business intelligence system. The contextual relationship comprises written text, a diagram or other annotations made by the user.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts a representative computing environment within which the teachings herein may be practiced.

FIG. 2 illustrates a representative block diagram of a client-server system, in accordance with embodiments of the present invention.

FIG. 3 illustrates a block diagram of an exemplary client-server network for displaying a business intelligence report on a client computing device in a client-server network according to keywords and contextual information, in accordance with embodiments of the present invention.

FIG. 4 illustrates an example of an organizational ontology structure, in accordance with embodiments of the present invention.

FIG. 5 illustrates an example of a data dictionary for an organization, in accordance with embodiments of the present invention.

FIG. 6 illustrates an exemplary flowchart for the keyword and content acquisition module, in accordance with embodiments of the present invention.

FIG. 7a illustrates an exemplary display for a client computing device showing a user interface for capturing text, in accordance with embodiments of the present invention.

FIG. 7b illustrates an exemplary display for a client computing device showing a user interface for entering contextual information, in accordance with embodiments of the present invention.

FIG. 7c illustrates an exemplary display for showing a business intelligence report displayed on the original document on a client computing device, in accordance with embodiments of the present invention.

FIG. 7d illustrates an exemplary display for a client computing device showing a user interface for adding a drawing to the context acquisition module, in accordance with embodiments of the present invention.

FIG. 7e illustrates an exemplary display for a client computing device whereby the user modifies the keyword input for the search engine, in accordance with embodiments of the present invention.

FIG. 7f illustrates an exemplary display for a client computing device where a revised business intelligence report is presented on the display, in accordance with embodiments of the present invention.

FIG. 8 is a flowchart of representative steps that can be carried out to suggest additional objects or keywords, in accordance with embodiments of the present invention.

FIG. 9 illustrates a computer system used for implementing the methods of the present invention.

### DETAILED DESCRIPTION OF THE EMBODIMENTS

Disclosed herein are methods and systems that provide, through a web-based user interface, a tool that allows users to select text, write text, and draw diagrams within online and offline content outside of the BI report environment to generate BI reports. With this invention, the user generates a contextual relationship between the user-input keywords and information to generate reports meeting their needs. Business intelligence requirements can be defined through an interactive and intuitive drag-and-drop interface within the online and/or offline context without the need to open a specific BI report.

The method of capturing business intelligence information from non-BI content, includes: (a) selecting at least one keyword from an electronic document being viewed outside of the environment of BI reports, such as web page, social media site, newspaper, blog, industry report, etc.; (b) defining a contextual relationship between the keyword(s) and a business intelligence issue by way of user input; (c) performing a search of the keyword(s) and the contextual relationship in a data dictionary and/or an ontology hierarchy stored in a business intelligence system; and (d) generating a business intelligence report based on a result of the search.

Also disclosed herein is a system for generating business intelligence contextual relationships among selected words, phrases, ideas, etc., including: a keyword selection and contextual relationship interface that generates a search criteria, via a keyword and context acquisition module, based on user input to define a plurality of keywords and a user-input contextual relationship(s) for the keywords. A business intelligence output interface processor generates business intelligence output, where the business intelligence output is based on a search of a data warehouse and an ontology hierarchy layer expressed as a BI report.

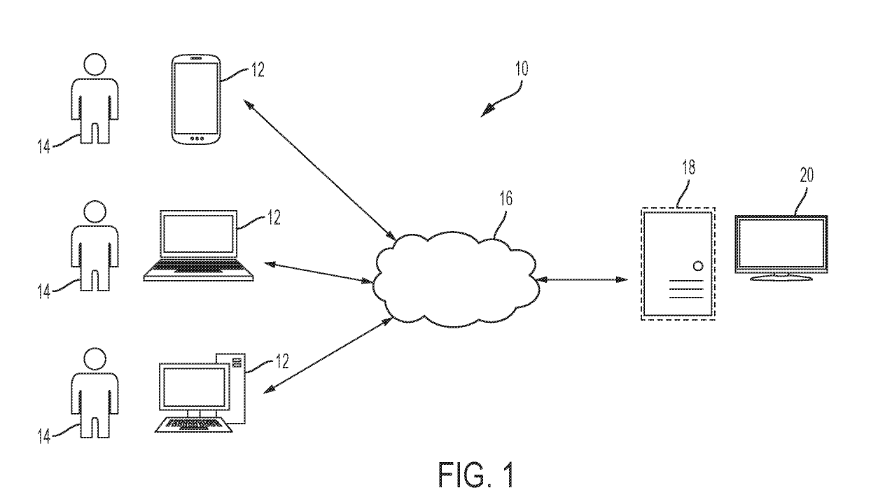

FIG. 1 depicts a representative computing environment 10 in which the teachings herein can be practiced. Environment 10 generally includes a plurality of client or user computing devices 12, each belonging to and/or used by a corresponding client or user 14. Although only three computing devices 12 and corresponding users 14 are shown in FIG. 1, this is only for the sake of illustration, and environment 10 can include any number of computing devices 12 and corresponding users 14 without departing from the instant teachings.

Client computing devices 12 can be any computing device including, without limitation, general purpose computers, special purpose computers, distributed computers, desktop computers, laptop computers, tablet computers, smartphones, and the like. In general, client computing devices 12 include a processor, memory (e.g., random access memory, or “RAM”), storage (e.g., a mechanical hard drive or solid state drive), and a display. As used herein, the term “processor” refers not only to a single central processing unit (“CPU”), but also to a plurality of CPUs, commonly referred to as a parallel processing environment. Client computing devices 12 can also include additional devices, such as various input devices (e.g., keyboards, trackpads, touchscreens) and output devices (e.g., speakers, printers).

Client computing devices 12 are coupled to a network 16, such as a local area network (“LAN”) or the Internet. Thus, client computing devices 12 and/or users 14 can communicate with each other over network 16. The ordinarily skilled artisan will be familiar with numerous ways to connect client computing devices 12 to network 16, including via wire (e.g., Ethernet) or via a wireless connection (e.g., 802.11, Bluetooth). Amongst other capabilities, client computing devices 12 can include a browser, such as Microsoft's Internet Explorer browser, Apple's Safari browser, Mozilla's Firefox browser, Google's Chrome browser, or the like, that can be used to access network 16 (for purposes of explanation and illustration, the Internet).

A server device 18 is also coupled to network 16, thus allowing client computing devices 12 to communicate with server device 18. Similar to client computing devices 12, server device 18 can include a processor, memory, storage, and a display 20, as well as additional devices. Moreover, although server device 18 is depicted as a single physical machine, it is contemplated that server device can be a distributed computing environment including multiple physical and/or virtual devices including multiple CPUs, multiple cores, and/or multiple threads.

A user interface can be established, for example, by server device 18 executing (e.g., by one or more processors) computer-readable program instructions that are stored in its memory and/or storage. The interface can be established on the display of a client computing device 12, such as in response to a request from client computing device 12 that takes the form of user 14 using the browser of client computing device 12 to visit a particular uniform resource locator (“URL”) for server device 18, and, more particularly, for the functions of server device 18 as described herein.

Common computational operations in a BI system are querying and filtering operations. Queries are used to create, modify, retrieve and manipulate data in a data source, such as, a database, a data warehouse, a plurality of reports, and the like. A filter is a condition used to limit information retrieved from a data source to a subset of the whole result of an unfiltered query. Filters are usually expressed in the form of a logical expression that states the condition. Often, users of BI tools are interested in limited subsets of records in a data source, so filtering operations are common. Filtering transforms the data into a small set of information making it suitable for analysis.

A report refers to information retrieved from a data source (e.g., a database, a data warehouse, and the like) based at least on raw data returned as part queries. Reports may be generated by applying data analytics operations to manipulate the raw data and the visualization of analytical data according to report schemas. Business objects can be used to specify the queries including the filters and the report schema thus enabling structuring of such reports using simple terms. There are BI applications that allow business objects to be dragged and dropped into the applications to create reports. One factor that could affect the data represented in the reports could be contextual information.

The contextual information that can affect a report can be in many different forms depending on the type of data represented in the report. For instance, a Global Positioning System (GPS) enabled sensor on a mobile device could supply location coordinates as contextual information to influence a report that relies on geography as one of its filter conditions. Similarly, radio frequency (RF) enabled temperature sensors could transmit temperature data as contextual information to a report influenced by temperature data. In one embodiment, the contextual information can be modeled as an entity of the ontology or data libraries comprising details about the parameters of a context of user's interest. The library may be defined by using a column or a field of the contextual entity, such kind of business libraries may be defined as contextual business information. For instance, the contextual business information can be used as a filter object to specify filtering criteria in a query. The contextual entity column or field could also be used to create a measure or a dimension type business objective. Thus, the contextual information may be a user-defined input, system-defined input, or derived from a sensor or other input device.

The business information can be used as a filter. When business information is a partial or total representation of a contextual entity field or column, a contextual filter is applied to filter the BI report based on the contextual information provided by a keyword and context acquisition module. Filters are applied to the data set via queries (e.g., Structured Query Language (SQL) queries and Multidimensional Expressions (MDX) queries) based on the user's context. The business objects can also be measures. When business information that is a partial or total representation of a contextual entity field or column defined as measures are applied to the BI report, a report calculation has to be performed. The contextual business information can also be dimensions. When business information that is a partial or total representation of a contextual entity field or column defined as a dimension are applied to the BI report, the cube sides, categories, columns or data sets are specified using the contextual data. In one aspect, the BI report is displayed to a user based on the contextual data provided by the contextual business information. Disclosed herein are methods and systems to display a BI report according to the contextual information of the user, by way of manual input by the user in identifying the contextual information influencing a BI report.

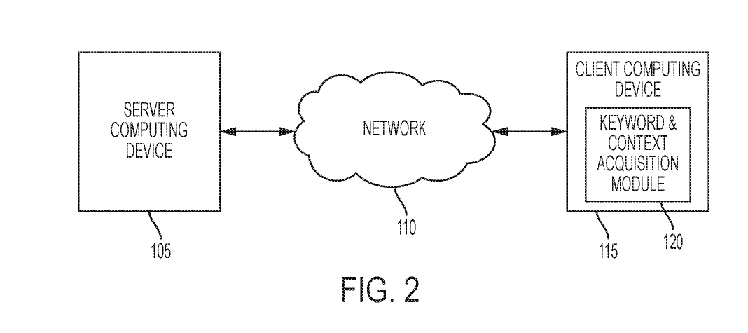

FIG. 2 is an exemplary block diagram illustrating a client-server system according to an embodiment of the invention. The block diagram includes a server computing device 105, a network 110, and a client computing device 115 including a context acquisition module 120. The server computing device 105 accepts requests or transmits responses associated with business information of an enterprise infrastructure. The server computing device 105 may also obtain one or more streams of the business information from a client computing device 115. The server computing device 105 communicates with the client computing device 115 through a network 110. In the embodiment, the client computing device 115 includes a keyword and context acquisition module 120 operable for obtaining or generating contextual information as will be described in more detail below. The client computing device 115 may include, but is not limited to, a personal computer, portable devices like personal digital assistants (PDA), mobile phone and wireless devices. The network 110 may include, but is not limited to, local area network (LAN), wide area network (WAN), metropolitan area network (MAN), public switched telephone network (PSTN), Bluetooth network, internet, intranet and Ethernet.

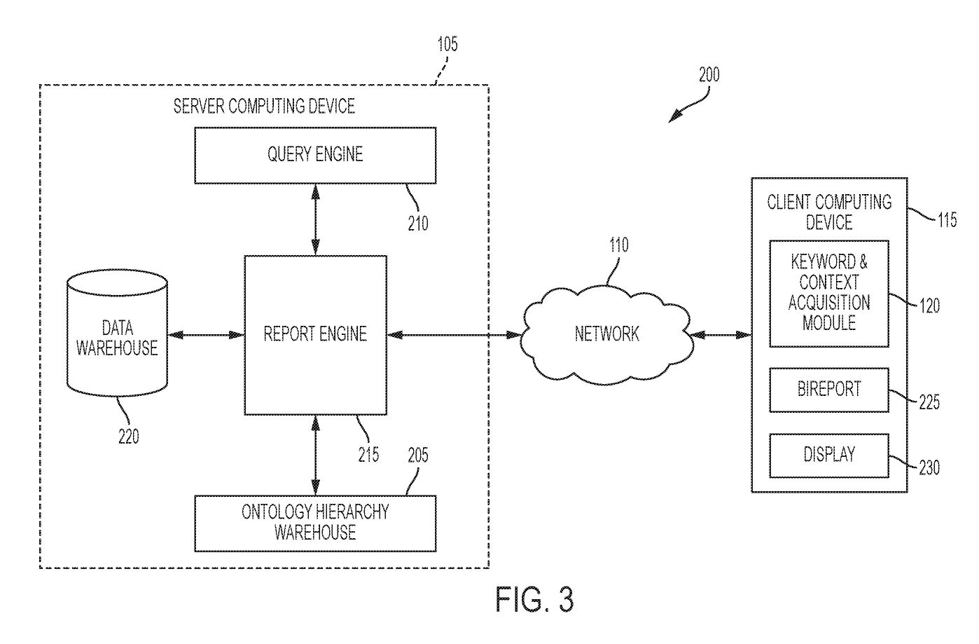

FIG. 3 is a block diagram of an exemplary client-server network for displaying a business intelligence report on a client computing device 115 in the client-server network according to selected keywords and contextual information. The client-server network 200 includes a server computing device 105, a network 110 and a client computing device 115. The server computing device 105 includes an ontology hierarchy warehouse 205, a query engine 210, a report engine 215 and a data warehouse 220. The client computing device 115 includes a keyword and context acquisition module 120 for generating contextualized BI report 225. The contextualized BI report is displayed on the display 230 of the client computing device 115.

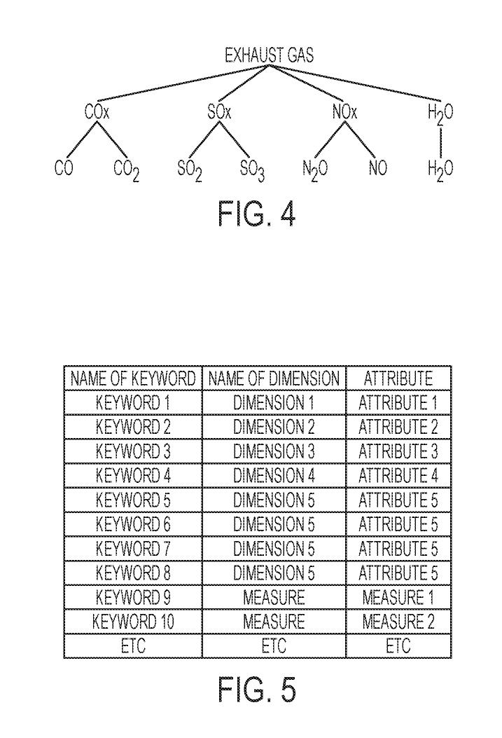

The ontology hierarchy warehouse 205 defines the data entities and their relations using a schema based on the data source metadata. The ontology hierarchy warehouse 205 interrelates business information that can be used by a business user as part of a search query. The business information is defined using tables, metadata and can contain calculations, family trees and other physical classifications of business information. The ontology hierarchy warehouse 205 also includes tables defining attributes, metadata based on an entity relationship model, dimension, measure, detail, stream adapter metadata, event driven metadata. The ontology hierarchy warehouse 205 also includes contextual entities, which are used for creating contextual business information. A schematic representation of one type of ontology hierarchy is illustrated in FIG. 4 showing a hierarchy of different types of exhaust gases and their relationship to each other. FIG. 5 illustrates an example of a data dictionary as is known in the art.

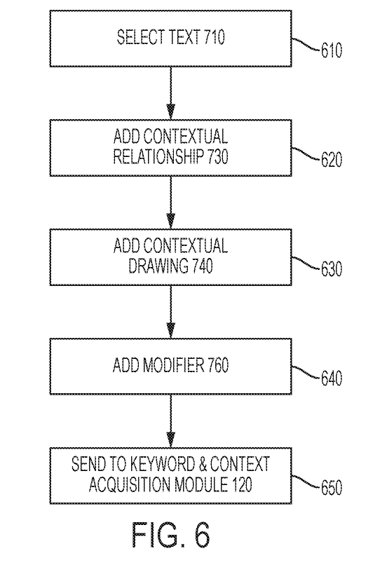

A user can define a query in the query engine 210 based on keywords chosen from words selected in a document, from text written by the user, and/or from diagrams drawn by the user, which drawings are identified in an image recognition system. When the user defines a query based on keywords and contextual relationships of those keywords in module 120, business objects having measures and dimensions associated with the user-defined query are retrieved from the ontology hierarchy warehouse 205 and the data warehouse 220. The business information allows a user to create queries based on user input and a representation of the ontology hierarchy 205 and data warehouse 220 designed by an administrator. In an embodiment, an ordinary business user defines a business query. The defined query is transmitted to the report engine 215. As discussed above, contextual data can be supplied to the query engine 210 and the report engine 215, for instance, to create and generate a contextualized BI report 225. The contextual data, in one embodiment, could come from the keyword and context acquisition module 120 which will be described in more detail below with reference to FIG. 6. In one embodiment, the client computing device 115 could be a mobile device and the mobile device itself could house the keyword and context acquisition module 120 for receiving user input related to keywords and contextual relationships. In the referenced embodiment, the user enters the contextual information manually via the context acquisition module 120 in the manner shown in FIG. 6.

In the described embodiment, the BI report and any updated BI report is preferably displayed on the display 230 of the client computing device 115 superimposed or interlaid over the original document from which the user selects the keywords and generates the contextual relationship of the keywords.

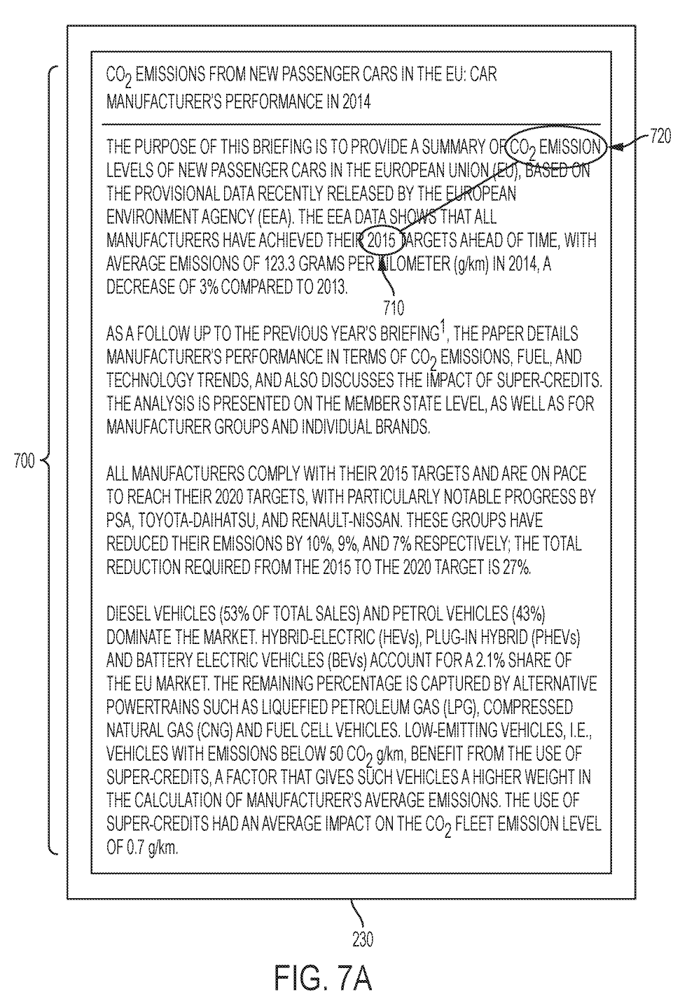

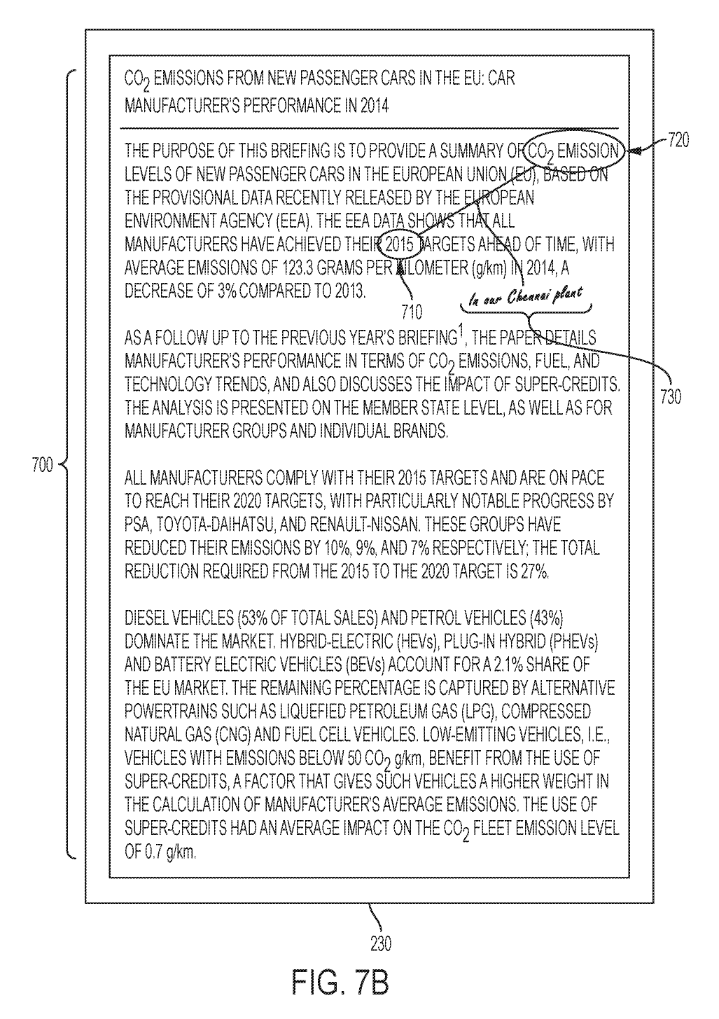

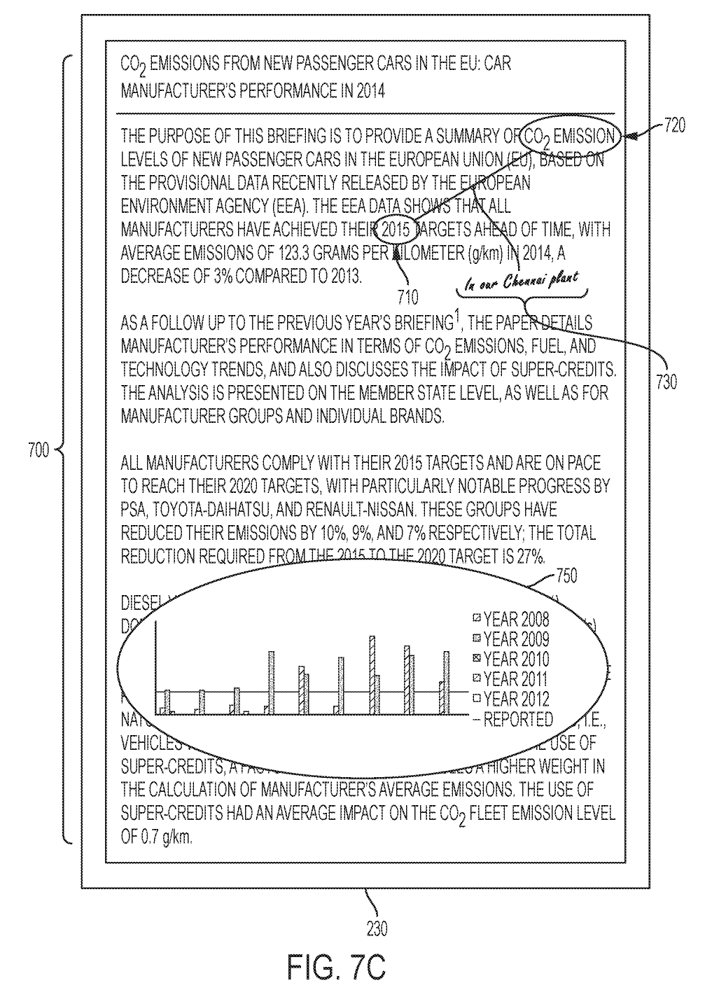

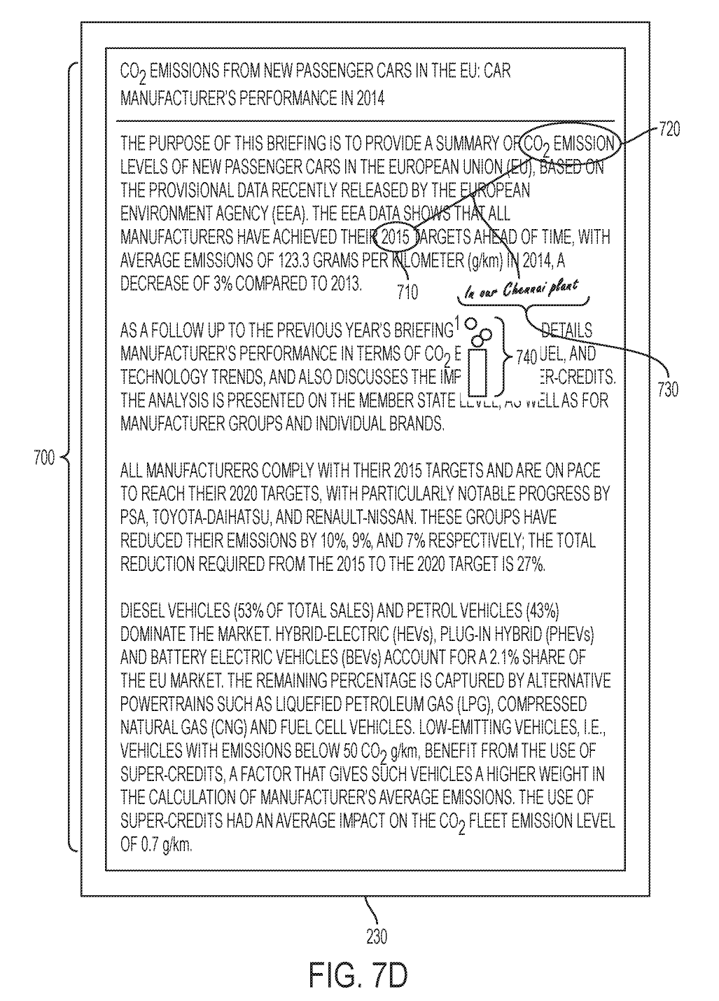

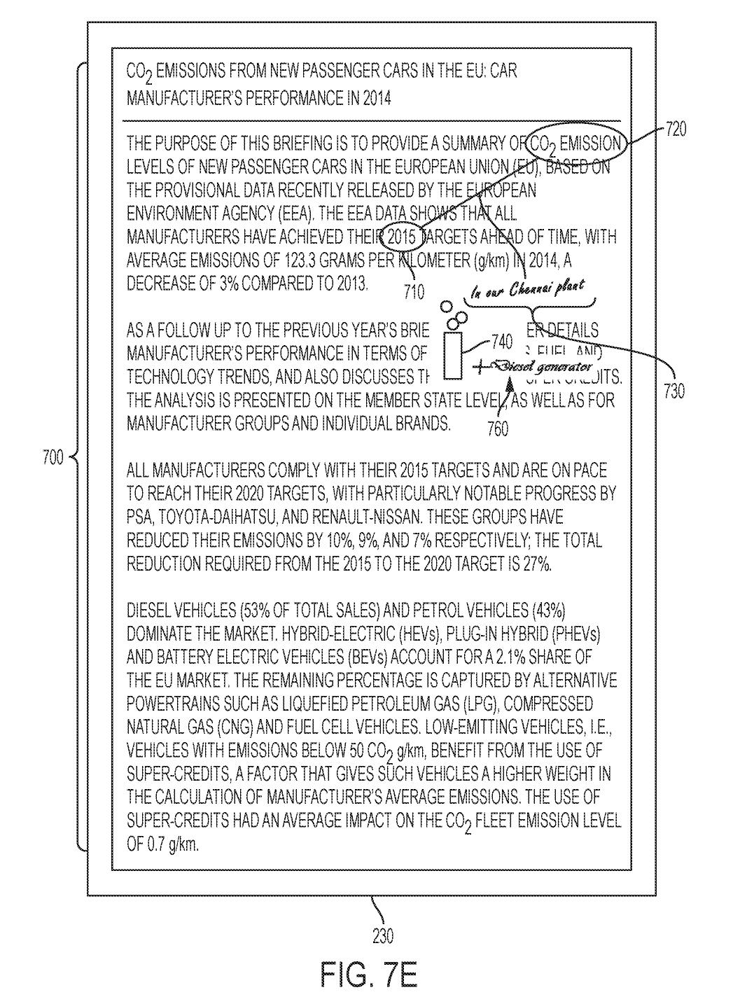

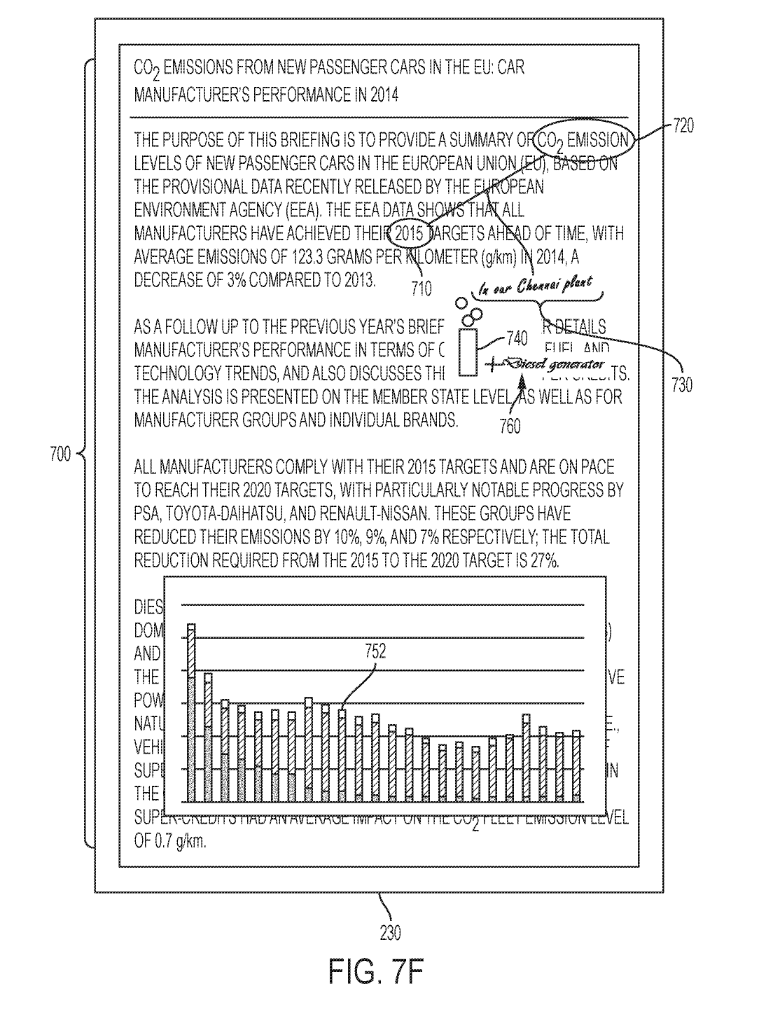

In one embodiment, client computing device 115 comprises software interfaces operable for communicating with the report engine 215 to supply the keyword(s) and contextual information provided by the user at the keyword and context acquisition module 120. With reference to FIGS. 7a-7f. FIG. 7a illustrates a display 230 of the client computing device 115 and having a document 700 entitled “CO2 emissions from new passenger cars in the EU: Car manufacturers' performance in 2014” describing a topic of interest to a user in an environment that is outside of the convention business intelligence arena, i.e., an industry report, a newspaper, a blog, social media, business journal, etc. When business users browse these types of documents 700, the business users may find the need to generate reports based on data provided in these documents without resorting to conventional business intelligence reporting software. As shown in FIG. 7a, this invention provides a system whereby the user may select certain keywords “2015” 710 and “CO2 emission” 720 from the document 700 in accordance with step 610 of FIG. 6. The user may select these keywords 710, 720 with any conventional text selection techniques as by highlighting, circling, underlining, etc. The system of this invention may also provide text selection techniques such as drop-down menus and the like to refine the keyword selection. The user may also desire to create a contextual relationship 730 between the selected keywords 710, 720 as shown in step 620 of FIG. 6. The contextual information may take the form of annotations made the user such as written text and/or diagrams as described below. In FIG. 7b, the user has created a contextual relationship 730, e.g. “in our Chennai plant”, by manually writing the text onto the display 230. Of course, the invention envisions other types of entry for the contextual relationship 730 such as typing, selection from a dropdown menu, voice recognition, etc. The annotations are user-made images that form part of the search query. According to the present invention, the user interface provides an input mechanism whereby the user may select keywords and input contextual relationships for the keywords in order to generate a search query which is delivered to the server computing device 105 via a network 110. Based on the search results, the system generates a business intelligence report in the form of chart 750 which is preferably displayed onto or overlaid upon the original document 700 as shown in FIG. 7c.

According to the present invention, the user may also refine or modify the keyword selection and/or context relationship by adding a contextual drawing 740 by hand drawing an image or selecting a predefined image from an image library. In the example shown in FIG. 7d, the user has added a drawing of a chimney 740 as contextual information for the keywords “2015” and “CO2 emission” and the contextual relationship “in our Chennai plant” to further refine the search of relevant business data from the data warehouse 220 and the ontology hierarchy warehouse 205. See step 630 of FIG. 6. In accordance with the invention, the user may add additional contextual information in the form of drawings to the display of the client computing device 115 to refine the search, whereby the resulting BI report is then displayed on the original document 700 for viewing by the user.

Furthermore, the user may add additional refinements to the search query by adding modifiers 760 such as shown in FIG. 7e. As shown in FIG. 7e, the user has hand-written the word “diesel generator” onto the display 230 or otherwise selected the word “diesel generator” from a menu selection to refine the search being delivered to the report engine 215. After being processed by the server computing device 105, an updated BI report 752 is generated by the system and displayed on the original document 700 in the display 230 as shown in FIG. 7f.

From the foregoing description, it will be clear that the present invention provides a system for generating business intelligence reports from sources outside of business intelligence applications such as web sites, blogs, newspapers, business journals and other online and offline documents typically viewed by those interested in business reports. The present invention provides a system whereby the user generates search criteria from selected text and creates contextual relationships within the relevant document, thereby creating a search criteria that is sent to a search engine which generates the BI report. The user may subsequently modify or refine the relevant search and view the BI report right on the display being used by the user to view the online and/or offline document.

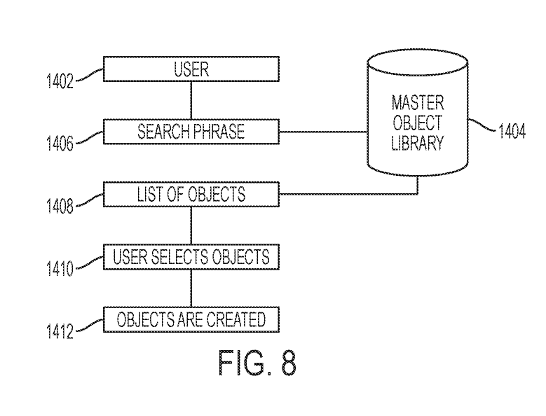

Although organizations typically have unique reporting requirements, there is still commonality in how different organizations report on their data. For example, many organizations divide data up by time segments—such as by time of day, date, week, month, quarter, etc., or some combination of time segments. To aid users in creating requirements more efficiently and thinking more broadly about the scope of requirements, FIG. 8 depicts a representative logic by which additional requirement objects can be suggested to user. For example, if user creates a concept named “Month” in block 1402, server device can search this concept against a master object library 1404 in block 1406. Because “Month” is commonly used in the time dimension, a list of suggested objects (e.g., Date, Week, Quarter, Year) can be output in block 1408. The user can select from the suggestion list in block 1410, and the selected concepts will automatically be added to the object library in block 1412.

The foregoing requirement suggestion feature can apply to all object types. For example, when a user creates a new measure named “Profit,” the suggestion list output in block 1408 can include other measures that comprise Profit, such as Cost and Revenue. The suggestion list can also include other related measures, such as Profit Last Year, Profit Year to Date, Profit % Growth vs. Last Year, and the like.

Moreover, when creating reports and dashboards, additional reports and dashboards may be suggested that will allow the data to be viewed at different levels of granularity and/or analyzed with different measures. For example, assume an organization reports data using the following concepts: Country, Region (where every Country contains one or more Regions), and State (where every Region contains one or more States). Additionally, the organization measures the success of the business using Profit measures (Cost, Revenue, Profit, and the like) and Customer Retention measures (# of Customers, % of Repeat Customers, and the like). When a user creates a report named “Profit by Region,” therefore, the suggestion list can include reports such as Profit by Country, Profit by State, and Customer Retention by Region.

Advantageously, by leveraging these requirement suggestions, users can be certain they have built a comprehensive set of requirements.

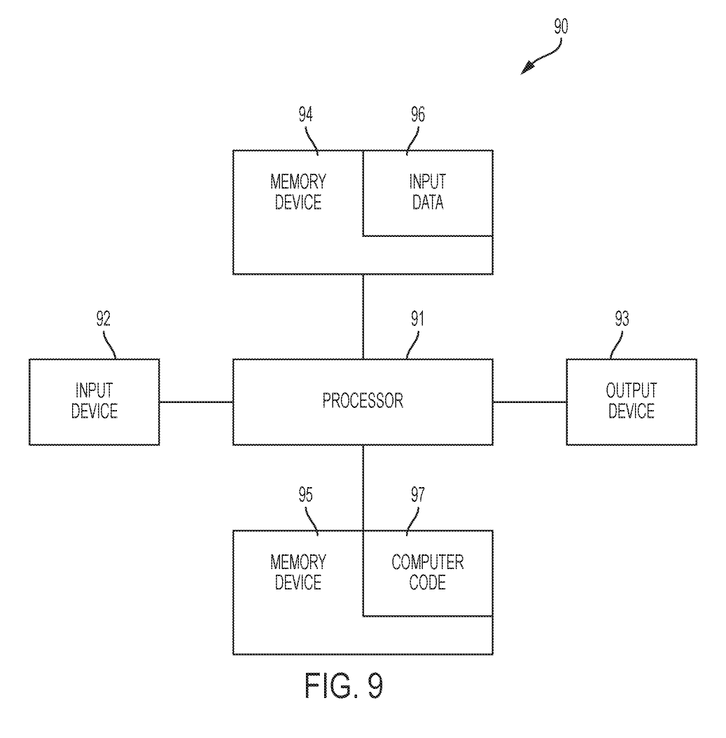

FIG. 9 illustrates a computer system 90 used for implementing the methods of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97 which is a computer program that includes computer-executable instructions. The computer code 97 includes software or program instructions that may implement an algorithm for implementing methods of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 9) may be used as a computer usable storage medium (or program storage device) having a computer readable program embodied therein and/or having other data stored therein, wherein the computer readable program includes the computer code 97. Generally, a computer program product (or, alternatively, an article of manufacture) of the computer system 90 may include the computer usable storage medium (or said program storage device).

The processor 91 may represent one or more processors. The memory device 94 and/or the memory device 95 may represent one or more computer readable hardware storage devices and/or one or more memories.

Thus the present invention discloses a process for supporting, deploying and/or integrating computer infrastructure, integrating, hosting, maintaining, and deploying computer-readable code into the computer system 90, wherein the code in combination with the computer system 90 is capable of implementing the methods of the present invention.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although certain embodiments of this invention have been described above with a certain degree of particularity, those skilled in the art could make numerous alterations to the disclosed embodiments without departing from the spirit or scope of this invention.

For example, the methods described herein can be either hardware- or software-implemented.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of generating a business intelligence report, the method comprising the steps of:
providing a user-operated device;
selecting at least one keyword from an electronic document displayed on said user-operated device;
defining a contextual relationship between said at least one keyword and a business intelligence issue by way of user input of annotations received by said user-operated device;
performing a search of said at least one keyword and said contextual relationship based on information stored in a business intelligence system;
generating a business intelligence report based on a result of said search.

2. The method of claim 1, further comprising:
defining an organization data dictionary and a structured ontology hierarchy in said business intelligence system, wherein said search is performed on said information within said data dictionary and said ontology hierarchy.

3. The method of claim 1, wherein said step of defining said contextual relationship comprises writing text and extracting at least one additional keyword from said text.

4. The method of claim 1, wherein said step of defining said contextual relationship comprises drawing a diagram related to predefined metadata and extracting at least one additional keyword from said diagram.

5. The method of claim 4, wherein said step of extracting at least one additional keyword comprises identifying a name of said diagram based on image recognition.

6. The method of claim 1, further comprising:
overlaying said business intelligence report over said electronic document on a computer screen.

7. The method of claim 1, further comprising:
generating report execution code to generate aid business intelligence report.

8. The method of claim 1, wherein said step of selecting comprises selecting a plurality of keywords, and wherein said contextual relationship links said plurality of keywords to said business intelligence issue.

9. The method of claim 1, wherein said step of defining comprises user input of text and an image.

10. The method of claim 1, wherein said contextual relationship defines filters for said search.

11. The method of claim 1, further comprising:
modifying said business intelligence report by adding at least one additional keyword or additional user input in the form of text or an image and producing a modified business intelligence report.

12. A computer program product, comprising:
a computer-readable storage device; and
a computer-readable program code stored in the computer-readable storage device, the computer-readable program code containing instructions that are executed by a central processing unit (CPU) of a computer system to implement a method of generating a business intelligence report, the method comprising the steps of:
the computer system receiving a selection by a user of at least one keyword embedded in an electronic document;
the computer system receiving a user defined contextual relationship between said at least one keyword and a business intelligence issue by way of user input;
the computer system performing a search of said at least one keyword and said contextual relationship in a business intelligence system;
the computer system generating a business intelligence report based on a result of said search.

13. The computer program product of claim 12, wherein the method further comprises the steps of:
defining an organization data dictionary and a structured ontology hierarchy in said business intelligence system, wherein said search is perform within said data dictionary and said ontology hierarchy.

14. The computer program product of claim 12, wherein said step of defining said contextual relationship comprises writing text and extracting at least one additional keyword from said text.

15. The computer program product of claim 12, wherein said step of defining said contextual relationship comprises drawing a diagram related to predefined metadata and extracting at least one additional keyword from said predefined metadata.

16. The computer program product of claim 15, wherein said step of extracting at least one additional keyword comprises identifying a name of said diagram based on image recognition.

17. The computer program product of claim 12, wherein the method further comprises the steps of:
overlaying said business intelligence report over said electronic document on a computer screen.

18. The computer program product of claim 12, further comprising:
generating report execution code to generate aid business intelligence report.

19. A computer system comprising:
a central processing unit (CPU);
a memory coupled to the CPU; and
a computer readable storage device coupled to the CPU, the storage device containing instructions that are executed by the CPU via the memory to implement a method of generating a business intelligence report, the method comprising the steps of:
the computer system receiving a selection by a user of at least one keyword embedded in an electronic document;
the computer system receiving a user defined contextual relationship between said at least one keyword and a business intelligence issue by way of user input;
the computer system performing a search of said at least one keyword and said contextual relationship in a data dictionary and an ontology hierarchy;
the computer system generating a business intelligence report based on a result of said search.

20. The computer system of claim 19, wherein said step of defining said contextual relationship comprises the steps of:
writing text and extracting at least one additional keyword from said text; and
drawing a diagram related to predefined metadata and extracting a further keyword from said predefined metadata.
